(19) United States
(12) Patent Application Publication
(10) Pub. No.: US 2003/0047649 A1
(43) Pub. Date: Mar. 13, 2003

(54) Support element for suspending elongate objects from a ceiling

(76) Inventors: Stefan Miescher, Schaan (CH); Remo Kluser, Hinterforst (CH); Stefan Boes, Waldshut-Tiengen (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/225,882

(22) Filed: Aug. 19, 2002

(30) Foreign Application Priority Data
Aug. 22, 2001 (DE) 101 40 195.7

(51) Int. Cl. F16L 3/00; E21F 17/02

(52) U.S. Cl. 248/58

(57) ABSTRACT

A support element for suspending elongate objects from a ceiling (4) and including a bent attachment part (2) securable to the ceiling, and a substantially hook-shaped support part (1) located opposite the attachment part (2) and pivotable relative thereto so that in its pivotal position, the support part (1) lies at least partially outside of a perpendicular projection of the attachment part (2) to a plane (B) of the attachment part (2).

### BACKGROUND OF THE INVENTION

1. Field of the Invention

The present invention relates to a support element for suspending elongate objects, such as cables, pipes, and the like, from a ceiling and including a bent attachment part securable to the ceiling, and a substantially hook-shaped support part located opposite the attachment part.

2. Description of the Prior Art

Support elements of the type described above serve for suspending, e.g., cables and pipes. The support element is formed of a strip material. The hook-shaped support part serves for suspending the elongate objects, with pressure being applied to the support part by the gravity force of the suspended objects. As an attachment element, a conventional dowel can be used. The dowel, e.g., can extend through the attachment part and into the ceiling. Another possibility of securing the support element to the ceiling consists in securing the attachment part, e.g., with a nail extendable through the attachment part and driven into the ceiling with an explosive powder charge-operated setting tool.

U.S. Pat. No. 3,323,766 discloses a support element having an attachment part or section and a support part or section. The attachment part has an opening and is securable to a ceiling or a rail, e.g., with a screw or the like.

An advantage of this support element consists in that the attachment part is located opposite the support part. Such an arrangement eliminate the lever action between the load applied to the support part and the attachment part, in particular, when the attachment part is secured to a ceiling. As a result, by an optimal distribution of the load, high load values of the attachment part can be achieved.

The drawback of the support element disclosed in U.S. Pat. No. 3,323,766 consists in that the attachment element can be driven through the attachment part only with much difficulty. The support part, which is located opposite the attachment part, makes securing of the attachment part to the ceiling with the attachment element very difficult if at all possible, in particular, with a setting tool.

Accordingly, an object of the present invention is to provide a support element of the type described above which can reliably withstand high load values and, at the same time, can be easily secured to a ceiling or the like.

### SUMMARY OF THE INVENTION

This and other objects of the present invention, which will become apparent hereinafter, are achieved by providing a support element in which the support part pivots relative to the attachment part and lies, in its pivotal position, at least partially outside of a perpendicular projection of the attachment part to a plane of the attachment part.

The pivoting of the support part relative to the attachment part insures an optimal accessibility of the attachment part for the attachment element. The support part is pivoted relative to the attachment part until a satisfactory accessibility for a setting tool, in particular, an explosive powder charge-operated setting tool, is achieved. After the attachment part has been secured to, e.g., a ceiling, the support part is pivoted back to its normal support position in which the support part is located opposite the attachment part. In this position, the to-be-suspended object or objects are placed into the hook portion of the support part. Because the load does not lead to any lever action on the attachment part, the support element can withstand large loads.

In order to provide for a simple handling of the support element, the support part is pivoted about an axis that extends parallel to the plane of the attachment part. Also, pivoting of the support part about an axis, which extends parallel to the plane of the attachment part, simplifies manufacturing process making it, thereby, very economical. However, within the field of application of the support element according to the present invention, the support part can pivot about an axis extending transverse to the plane of the attachment part.

In order to insure a high stability of the support element in the region of the pivot axis, advantageously, the support and attachment parts overlap each other in this region, at least partially.

Advantageously, there is provided a locking means for fixedly connecting the support and attachment parts with each other.

Advantageously, the locking means comprises an opening provided in one of the support and attachment parts, and an engagement tongue provided in another of the support and attachment parts. The locking means according to the present invention is constructively simple, is easily manufacturable, and is easy to handle. Preferably, the opening is formed in the support part, and the engagement tongue is provided on the attachment part. If for a particular case, it is desirable that the support part occupies several positions with respect to the attachment part, a plurality of openings is formed in the support part.

In order to prevent a pivotal movement of the support and attachment parts relative to each other when a load is applied to the support part, the locking means locks the two part in the operational position of the support element. This is particularly advantageous when a dynamic load is applied to the support part.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side view of the support element according to the present invention in a non-pivotal position of the support part;

FIG. 2 a side view of the support element shown in FIG. 1, with the support part pivoted by 90°; and

FIG. 3 a perspective view, at an increased, in comparison with FIG. 1, scale of the support element shown in FIG. 1.

### DETAILED DESCRIPTION OF THE PREFERRED EMBODIMENT

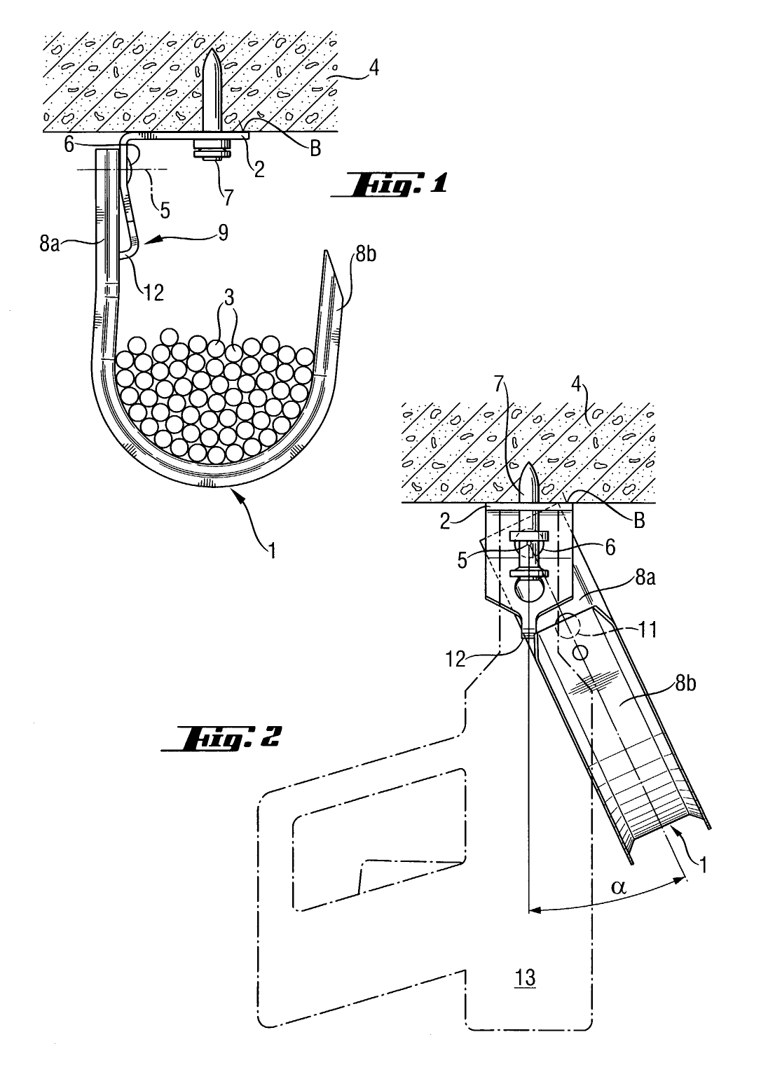

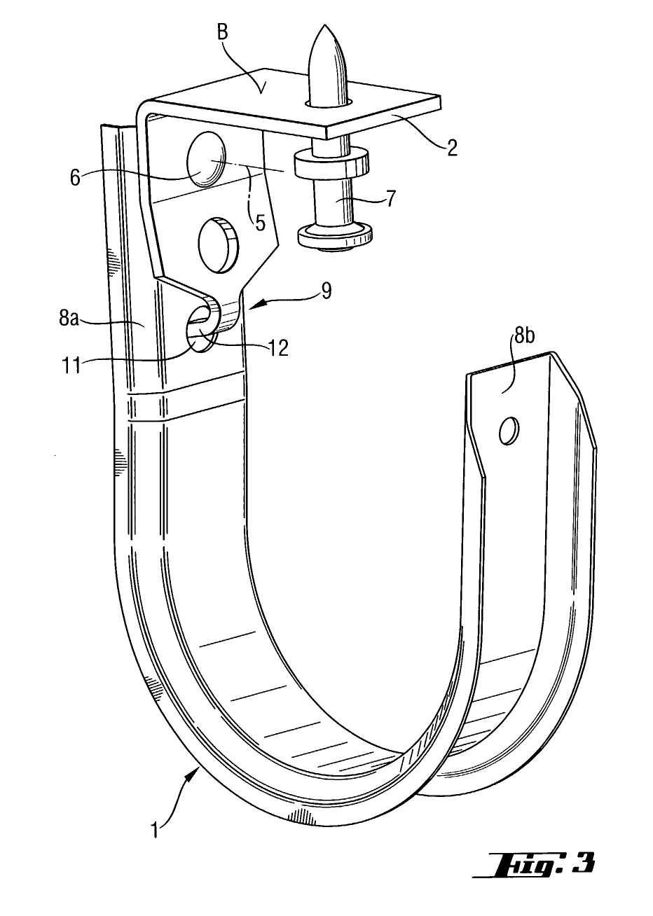

A support element, e.g., a cable holder, according to the present invention, which is shown in FIGS. 1-3 and is used for suspending, e.g., a cable 3 from a ceiling 4, has a bent attachment part 2 securable to the ceiling 4, and a hook-shaped support part 1 arranged opposite the attachment part 2. The support part 1 pivots relative to the attachment part 2 about a pivot axis 5. The support part 1 lies, at least partially, in its pivotal position, as particularly shown in FIG. 2, outside of a perpendicular projection of the attachment 2 to a plane B of the attachment part 2.

The bent attachment part 2 abuts the ceiling 4 and has, approximately in its middle, a through-bore extending perpendicular to the plane B of the attachment part 2 for receiving an attachment element 7.

The substantially hook-shaped support part 1 has a U-shaped cross-section, as particularly clearly shown in FIG. 3. One of the free longitudinal ends 8a, 8b of the support part 1 is pivotally connected with the attachment part 2 by a rivet 6 extending along the pivot axis 5 and parallel to the plane B of the attachment part 2. The attachment part 2 and the support part 1 partially overlap each other in the region of the pivot axis 5.

For fixedly connecting the attachment part 2 and the support part 1, there is provided locking means 9. The locking means 9 consists of an opening 11 formed in the support part 1, and a springy engagement tongue 12 provided on the attachment part 2 and received in the opening 11. The locking means 9 prevents a pivotal movement of the support part 1 relative to the attachment part 2 in the end position of the cable holder shown in FIGS. 1 and 3. In this position, the springy engagement tongue 12 engages in the opening 11, releasably connecting the support part 1 with the attachment part 2.

FIG. 2 shows a pivotal position of the inventive cable holder, together with a schematically shown, explosive powder charge-operated, setting tool 13 used for securing the attachment part 2 to the ceiling 4. In order to secure the attachment part 2 with the drivable-in attachment element 7, in particular nail, the support part 1 is pivoted relative to the attachment part 2 by an angle α about the pivot axis 5. To provide for the pivotal movement of the support part 1, the locking means 9 is released, i.e., the springy engagement tongue 12 is disengaged from the opening 11 in the support part 1. Upon actuation of the setting tool 13, it drives the attachment element 7, the nail, through the attachment part 2 into the ceiling 4, securing the attachment part 2 to the ceiling 4. After the attachment part 2 having been secured to the ceiling 4, the support part 1 is pivoted into its end position shown in FIGS. 1 and 3, and is secured in this position by the insertion of the tongue 12 into the opening 11. In this position, one or several objects can be placed in the support part 1.

Though the present invention was shown and described with references to the preferred embodiment, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. A support element for suspending elongate objects from a ceiling (4), the support element comprising a bent attachment part (2) securable to the ceiling; and a substantially hook-shaped support part (1) located opposite the attachment part (2) and pivotable relative thereto, the support part (1) lying, in a pivotal position thereof, at least partially outside of a perpendicular projection of the attachment part (2) to a plane (B) of the attachment part (2).

2. A support element according to claim 1, wherein the support part (1) pivots about a pivot axis (5) extending parallel to the plane (B) of the attachment part (2).

3. A support element according to claim 2, wherein the support part (1) and the attachment part (2) overlap at least partially in a region of the pivot axis (5).

4. A support element according to claim 1, further comprising looking means (9) for fixedly connecting the support and attachment parts (1, 2) with each other.

5. A support element according to claim 1, wherein the locking means (9) comprises an opening provided in one of the support and attachment parts (1, 2), and an engagement tongue (12) provided in another of the support and attachment parts (1, 2).
